(19) United States
(12) Patent Application Publication
(10) Pub. No.: US 2026/0002397 A1
(43) Pub. Date: Jan. 1, 2026

(54) VEHICLE DOOR OPENER WITH ANTI-BACKLASH STRUCTURE

(71) Applicant: DAEDONG DOOR Incorporated, Incheon (KR)

(72) Inventors: Hang Jin CHO, Incheon (KR); Jun Hyun Jo, Incheon (KR)

(73) Assignee: DAEDONG DOOR Incorporated, Incheon (KR)

(21) Appl. No.: 19/234,922

(22) Filed: Jun. 11, 2025

(30) Foreign Application Priority Data
Jun. 27, 2024 (KR) 10-2024-0084132

(51) Int. Cl. E05F 5/02; E05F 15/611

(52) U.S. Cl. CPC E05F 5/025; E05F 15/611; E05Y 2201/21; E05Y 2201/26; E05Y 2201/488; E05Y 2201/704; E05Y 2900/531

(57) ABSTRACT

A vehicle door opener including an anti-backlash structure is disclosed. According to the present disclosure, a vehicle door opener can be provided, which includes a checker arm which is hinge-coupled to a main body of a vehicle and in which a screw thread is formed on an outer circumferential surface of the checker arm, a main part which moves along the checker arm when a door is opened or closed, a motor part which moves the main part, and a cover part in which the checker arm and the main part are disposed, wherein the main part includes a worm wheel which is engaged with the outer circumferential surface of the checker arm and of which both sides are formed to extend based on a portion with which a worm of the motor part is engaged, a nut part which is engaged with the outer circumferential surface of the checker arm and disposed at one side of the worm wheel, and an elastic part which is formed of a member having an elastic restoring force and disposed to surround outer circumferential surfaces of the worm wheel and the nut part to push the worm wheel and the nut part in opposite directions.

### CROSS-REFERENCE TO RELATED APPLICATION

This application claims priority to and the benefit of Korean Patent Application No. 10-2024-0084132, filed on Jun. 27, 2024, the disclosure of which is incorporated herein by reference in its entirety.

### BACKGROUND

### 1. Field of the Invention

Embodiments of the present disclosure relate to a vehicle door opener with an anti-backlash structure.

### 2. Discussion of Related Art

Backlash means a gap formed in a movement direction of mechanical apparatuses having screws and toothed wheels. The backlash is required for a pair of mechanical apparatuses to smoothly rotate. However, since lubrication may be insufficient when backlash is too small, friction between tooth surfaces increases, and thus excessive rotational resistance and wear may occur. Conversely, since engagement between a pair of mechanical apparatuses is loosened and a separation space therebetween may be generated when backlash is too large, vibrations and noise are generated, correct control is impossible, and an early wear phenomenon may occur.

That is, when backlash is too small, it is not good because of power loss (resistance), and when backlash is too large, it is not good because of an increase in possibility of damage to gears. Accordingly, in mechanical apparatuses which are engaged with each other and operated, it is important to form backlash with a proper distance. In addition, even backlash gradually increases as tooth surfaces are worn due to continuous operation of mechanical apparatuses.

In this regard, it is becoming important to properly maintain backlash in a vehicle door opener in which mechanical apparatuses are engaged with each other and operated. Specifically, in mechanical apparatuses in which backlash is properly maintained, a lifetime can increase, and operability can be improved.

The above description is provided to facilitate understanding of the technical background of the present disclosure. Accordingly, the above description should not be used to reduce, limit, and restrict the technical spirit of the present disclosure. In addition, the contents described or implied above do not necessarily mean conventional technologies. Some of the above description may include a content which does not correspond to the conventional technology.

### SUMMARY OF THE INVENTION

Embodiments of the present disclosure are directed to a vehicle door opener with an anti-backlash structure, which suppresses the generation of vibrations and noise and improves operability.

However, technical objects to be achieved through the embodiments of the present disclosure are not necessarily limited to the above-described technical objects. Other technical objects that are not described above may be clearly understood by those skilled in the art to which the present disclosure belongs from the other descriptions of the specification such as the detailed description.

According to an aspect of the present invention, there is provided a vehicle door opener which includes a checker arm which is hinge-coupled to a main body of a vehicle and in which a screw thread is formed on an outer circumferential surface of the checker arm, a main part which moves along the checker arm when a door is opened or closed, a motor part which moves the main part, and a cover part in which the checker arm and the main part are disposed, wherein the main part includes a worm wheel which is engaged with the outer circumferential surface of the checker arm and of which both sides are formed to extend based on a portion with which a worm of the motor part is engaged, a nut part which is engaged with the outer circumferential surface of the checker arm and disposed at one side of the worm wheel, and an elastic part which is formed of a member having an elastic restoring force and disposed to surround outer circumferential surfaces of the worm wheel and the nut part to push the worm wheel and the nut part in opposite directions.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a front perspective view illustrating a vehicle door opener according to one embodiment of the present disclosure;

FIG. 2 is a rear perspective view illustrating the vehicle door opener illustrated in FIG. 1;

FIG. 3 is an enlarged view illustrating a motor case and a stepped case illustrated in FIG. 1;

FIG. 4 is a view illustrating the interior of the vehicle door opener illustrated in FIG. 1;

FIG. 5 is an enlarged view illustrating the interior of a main case illustrated in FIG. 1;

FIG. 6 is an enlarged view illustrating a main part illustrated in FIG. 4;

FIG. 7 is an exploded view illustrating the main part illustrated in FIG. 4;

FIG. 8 is an enlarged view illustrating a nut part illustrated in FIG. 4;

FIG. 9 is an enlarged view illustrating a worm wheel illustrated in FIG. 4; and

FIG. 10 is a cross-sectional view illustrating the vehicle door opener illustrated in FIG. 1.

### DETAILED DESCRIPTION OF EXEMPLARY EMBODIMENTS

Hereinafter, embodiments of the present disclosure will be described with reference to the accompanying drawings.

Following embodiments are provided to fully and completely transfer the technical spirit of the present disclosure to those skilled in the art to which the present disclosure belongs. Therefore, the technical disclosure of the present disclosure is not necessarily limited to the following embodiments. The present disclosure should be understood broadly to include various equivalents, alternatives, and modifications that implement the technical spirit which will be described below.

Terms used in the following description are used to fully and completely describe specific embodiments from the above-described viewpoint. Accordingly, the terms used in the following description should not be interpreted to reduce, limit, and restrict the technical spirit of the present disclosure and the like.

In the following description, terms such as “first” and “second” may be used to distinguish a specific component from other components. However, such terms are used for clarity of description only, and the technical spirit of the present disclosure should not be constructed as limited by such terms.

A singular expression includes a plural expression unless it is not clearly excluded in context. In addition, in the following description, the expression of “including” means the presence of the configurations, components, operations, features, steps, numbers, etc., described in the specification, and does not exclude addition of one or more other configurations, components, operations, features, steps, numbers, etc.

In the following description, directionally relative terms such as “beneath,” “above,” “lower,” and “upper” may be used for facilitating understanding of components. However, such terms are provided for facilitating understanding of the present disclosure according to various operation states, use states, etc., of the present disclosure and should not be interpreted for reducing, limiting, or restricting the technical spirit of the present disclosure. For example, terms related to direction may be determined according to a relative point of view.

Meanwhile, each component illustrated in the accompanying drawings may be exaggerated or omitted for the sake of convenience and clarity of description.

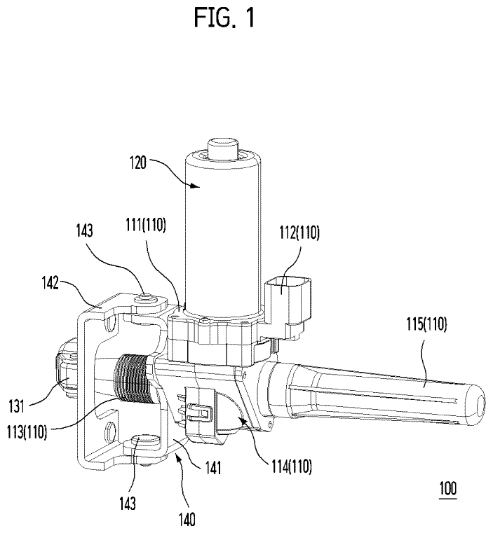

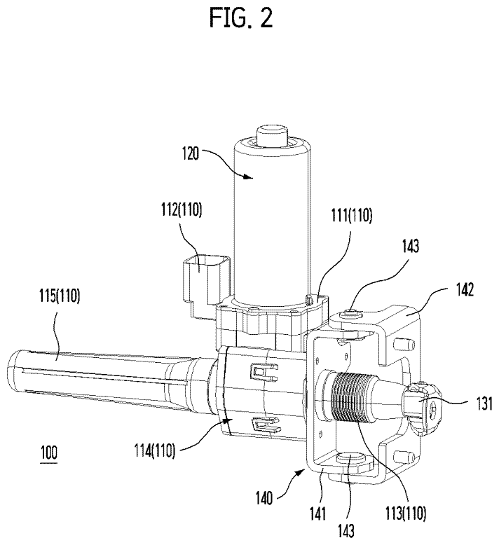

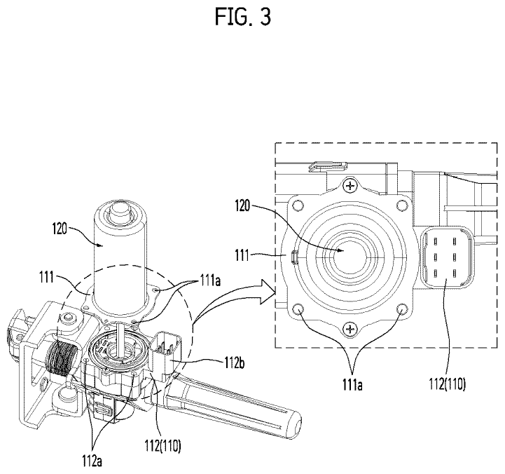

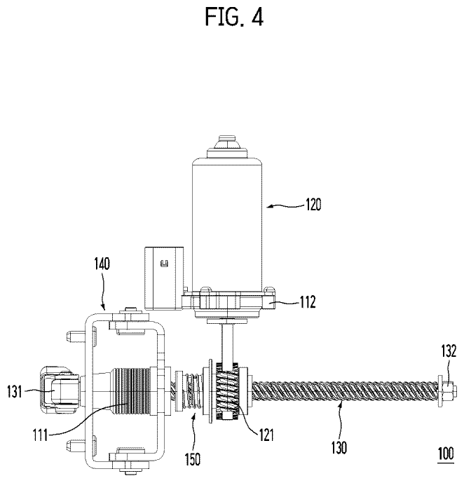

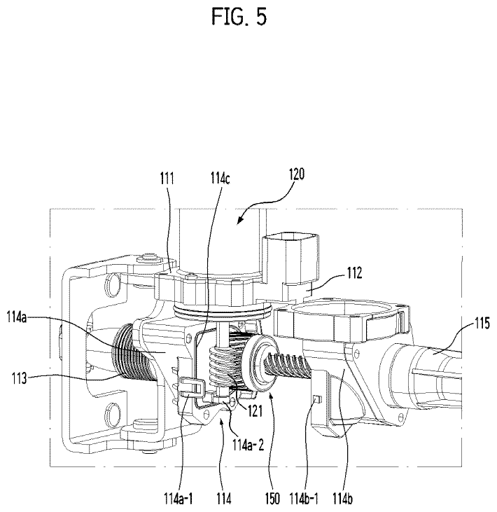

FIG. 1 is a front perspective view illustrating a vehicle door opener according to one embodiment of the present disclosure, and FIG. 2 is a rear perspective view illustrating the vehicle door opener illustrated in FIG. 1. FIG. 3 is an enlarged view illustrating a motor case and a stepped case illustrated in FIG. 1, and FIG. 4 is a view illustrating the interior of the vehicle door opener illustrated in FIG. 1. FIG. 5 is an enlarged view illustrating the interior of a main case illustrated in FIG. 1.

Referring to FIGS. 1 to 5, a vehicle door opener 100 of the present embodiment may be disposed between a door and a vehicle body of a vehicle to open or close the door of the vehicle. Specifically, the vehicle door opener 100 of the present embodiment may include a checker arm 130 formed to have a length so as to restrict an opening angle of the door and a main part 150 into which the checker arm 130 is inserted and which moves forward and backward in a longitudinal direction. The checker arm 130 and the main part 150 may operate to interact to each other.

In addition, the main part 150 of the present embodiment may include an anti-backlash structure to improve operability. A cover part 110 is formed with a unique structure to have effects of improving assemblability and water tightness.

Specifically, the vehicle door opener 100 may include the cover part 110 in which the checker arm 130 and the main part 150 are disposed, a motor part 120 which operates the main part 150, the checker arm 130 formed to extend at the length so as to restrict the opening angle of the door, a bracket 140 fixed to the door of the vehicle, and the main part 150 into which the checker arm 130 is inserted and which moves in the longitudinal direction.

Hereinafter, the components will be described in more detail.

The cover part 110 may be formed of a member having an inner space, and the checker arm 130 and the main part 150 may be disposed in the cover part 110. Specifically, the cover part 110 may be disposed to prevent foreign matter from being introduced into the checker arm 130 and the main part 150. In addition, the cover part 110 of the present embodiment may be formed such that assembly is easily performed, and thus assemblability can be improved such that the assembly is simply and conveniently performed.

Specifically, the cover part 110 may include a motor case 111 in which the motor part 120 is disposed, a terminal case 112 disposed between the motor part 120 and the main part 150 to be connected to a terminal (not shown), an extendable case 113 of which a length is variably changed, a main case 114 in which the main part 150 is disposed, and a fixing case 115 which is disposed at one side of the main case 114 and covers an end of the checker arm 130.

The motor case 111 may be formed in a shape corresponding to the terminal case 112 to be connected to the terminal case 112 and disposed at one side of the motor part 120. The motor case 111 may be formed of a plate member and connected to the terminal case 112. Preferably, the motor case 111 may be formed of the quadrangular plate member and fixedly connected to the terminal case 112. For example, the motor case 111 may be connected to a member having an inner space such that the motor part 120 is disposed in the member, or disposed at one side of the motor part 120 to be connected to the motor part 120.

Specifically, the motor case 111 may include a fastening hole 111a, and a fastening member may pass through the fastening hole 111a of the motor case 111 and the terminal case 112. The fastening hole 111a may be open vertically in the motor case 111 and may be provided as a plurality of fastening holes 111a. The fastening hole 111a of the motor case 111 and a fastening hole 112a formed in the terminal case 112 may be fixedly fastened by the fastening member (not shown) passing through the fastening hole 111a of the motor case 111 and the fastening hole 112a formed in the terminal case 112. Preferably, the plurality of fastening holes 111a may be disposed to be spaced an equal interval from each other so that the terminal case 112 may be rotated and coupled as needed. For example, the fastening holes 111a may be disposed to be spaced an equal interval from each other at an edge of the quadrangular motor case 111.

The terminal case 112 may be disposed at one side of the motor case 111 and fixedly connected to the motor case 111. Specifically, the terminal case 112 may be disposed for connecting an electric wire or certain device for controlling or monitoring the vehicle door opener 100. Preferably, the terminal case 112 may be formed of a quadrangular plate member to correspond to the motor case 111 and fixedly connected to the motor case 111.

Specifically, the terminal case 112 may include the fastening hole 112a disposed to be connected to the motor case 111 and a terminal connector 112b disposed to protrude at one side of the terminal case 112

The fastening hole 112a may be a hole disposed to vertically pass through the terminal case 112 and may be provided as a plurality of fastening holes 112a. The fastening hole 112a of the terminal case 112 and the fastening hole 111a of the motor case 111 may be fixedly fastened by the fastening member (not shown) passing through the fastening hole 112a of the terminal case 112 and the fastening hole 111a of the motor case 111. That is, the fastening hole 112a may be formed to correspond to the fastening hole 111a of the motor case 111a and connected to the fastening hole 111a by the fastening member (not shown) passing through the fastening hole 112a and the fastening hole 111a of the motor case 111a.

The terminal connector 112b may be disposed at one side surface of the terminal case 112 and connected to an electric wire or certain device for controlling and monitoring the vehicle door opener 100. Specifically, the terminal connector 112b may be selectively disposed at a left side, right side, upper side, or lower side of the motor part 120 according to an inner space of the vehicle in which the vehicle door opener 100 is disposed.

The terminal case 112 and the motor case 111 may be formed of the quadrangular plate members, and both the fastening holes 111a and 112a may be disposed to be spaced an equal interval from each other. As needed, the terminal case 112 may be rotation-coupled to the motor case 111 to change an arrangement direction of the terminal case 112. Specifically, the terminal case 112 may be rotated according to a position at which the terminal connector 112b is disposed, and fixedly connected to the motor case 111.

Meanwhile, the extendable case 113 may be formed in a shape of a flexible corrugate tube, so that the length of the extendable case 113 may increase or decrease according to movement of the main part 150. Specifically, the extendable case 113 may be disposed between a vehicle connector 131 of the checker arm 130 and the main case 114 and compressed and elongated according to movement of the main part 150. The extendable case 113 may be disposed to prevent foreign matter from being introduced into the checker arm 130 from the outside and prevent the checker arm 130 from being corroded.

The main case 114 may be formed of a member having an inner space, and the main part 150 may be disposed in the main case 114. The main case 114 of the present embodiment may be separately formed and coupled and thus easily fastened and assembled. Preferably, the main case 114 is formed as a pair of main cases 114 separated in a width direction, and the pair of main cases 114 may be fixedly fastened to each other and simply and conveniently coupled without a separate fastening member so that assembly is easy.

Specifically, the main case 114 may include a first main body cover 114a and a second main body cover 114b which are separately formed and coupled to each other to seal the main part 150 and a packing part 114c disposed between the first main body cover 114a and the second main body cover 114b to improve sealing therebetween.

The first main body cover 114a and the second main body cover 114b may be fixedly fastened to each other with the main part 150 interposed therebetween. Specifically, the first main body cover 114a and the second main body cover 114b may be formed such that a space is formed therein and facing portions are coupled.

Specifically, the first main body cover 114a may include a hook 114a-1 in which a member, in which a hole or groove is formed, is disposed on an outer circumferential surface of the first main body cover 114a and a support 114a-2 which supports a lower end of a worm 121.

The hook 114a-1 may be formed of the member in which the hole or groove is formed on the outer circumferential surface of the first main body cover 114a and fastened to a fastening protrusion 114b-1 of the second main body cover 114b. Preferably, in the hook 114a-1, the hole or groove having a shape corresponding to the fastening protrusion 114b-1 may be formed and fixedly fitted onto the fastening protrusion 114b-1.

The support 114a-2 may be formed to protrude toward a lower side of the worm 121 in the first main body cover 114a and disposed to be in contact with or close to the lower end of the worm 121. Preferably, the support 114a-2 may be provided as a bar horizontally extending and disposed under the worm 121. The support 114a-2 may be disposed to prevent the worm 121 from sagging downward. Specifically, the support 114a-2 may support the worm 121 which gradually descends when the vehicle door opener 100 operates for a long time. That is, the support 114a-2 may be disposed such that the worm 121 is always positioned at the same position.

The second main body cover 114b may include the fastening protrusion 114b-1 formed to protrude from an outer circumferential surface to be fixedly fastened to the hook 114a-1. The fastening protrusion 114b-1 may be formed as a protrusion corresponding to the hook 114a-1 to protrude from the outer circumferential surface of the second main body cover 114b. Preferably, the fastening protrusion 114b-1 may be formed to further protrude outward (in a direction in which the fixing case 115 is disposed) to easily fix the hook 114a-1.

Specifically, the fastening protrusion 114b-1 may be formed to have an inclined surface which gradually protrudes from a portion coupled to the first main body cover 114a in the direction in which the fixing case 115 is disposed. That is, the hook 114a-1 may be smoothly moved along the inclined surface of the fastening protrusion 114b-1 and then fastened to a most protruding end to easily and fixedly fasten the first and second main body covers 114a and 114b.

The packing part 114c may be disposed between the first main body cover 114a and the second main body cover 114b to improve the sealing between the first main body cover 114a and the second main body cover 114b. Specifically, the packing part 114c may be disposed on circumferential surfaces of contact surfaces of the first main body cover 114a and the second main body cover 114b. That is, the packing part 114c may firmly couple the first main body cover 114a and the second main body cover 114b. Preferably, at least a portion of the packing part 114c may be formed of a material having an elastic restoring force.

Meanwhile, the fixing case 115 may be formed of a cylindrical member having an inner space and disposed to be connected to a third main part 114d of the main case 114. Specifically, in the fixing case 115, the checker arm 130 disposed to pass through the third main part 114d may be disposed, and a stopper 132, which will be described below, may be disposed. More specifically, the length of the checker arm 130, which is disposed in the fixing case 115, withdrawn from the main part 150 may be changed according to movement of the main part 150. The fixing case 115 may be disposed to prevent foreign matter from being introduced into the checker arm 130 from the outside or to prevent the checker arm 130 from being corroded.

Meanwhile, the motor part 120 may be disposed to move the main part 150 relative to the checker arm 130. Specifically, the main part 150 engaged with the motor part 120 may be moved by operation of the motor part 120 such that the vehicle door opener 100 may open or close the door. Specifically, the motor part 120 may include the worm 121 rotated by operation of the motor part 120.

The worm 121 may be engaged with a worm wheel 151 of the main part 150 which will be described below such that the worm wheel 151 may be rotated by operation of the motor part 120.

Meanwhile, the checker arm 130 may be formed as a bar extending in the longitudinal direction and hinge-coupled to a main body of the vehicle. The checker arm 130 of the present disclosure may be formed as a spindle in which a screw thread is formed on an outer circumferential surface of the checker arm 130, and the main part 150 may move in a state of being engaged with the outer circumferential surface of the checker arm 130. The checker arm 130 may be formed to have the length such that the door of the vehicle may be maximally opened.

Specifically, the checker arm 130 may include the vehicle connector 131 connected to the main body of the vehicle and the stopper 132 which supports the main part 150 to prevent the main part 150 from being separated therefrom.

The vehicle connector 131 may be disposed on an end portion of one side of the checker arm 130 and hinge-coupled to the main body of the vehicle. That is, the vehicle connector 131 may operate as a hinge according to opening or closing of the vehicle door.

The stopper 132 may be disposed on the end of the checker arm 130 to prevent the main part 150 from being separated therefrom. For example, the stopper 132 may be formed in the form in which a washer and a nut are coupled to support the main part 150 to prevent the main part 150 from being separated therefrom. The stopper 132 may allow the main part 150 to move to the stopper 132 and prevent the main part 150 from passing over the stopper 132 and being separated from the checker arm 130.

Meanwhile, the checker arm 130 may pass through the bracket 140, one side of the bracket 140 may be connected to the main part 150, and the other side may be fixedly connected to the door of the vehicle. The bracket 140 may be disposed to be rotatable a predetermined extend to avoid interference between the checker arm 130 and components disposed such that the checker arm 130 passes through the components.

Specifically, the bracket 140 may include a first bracket 141 connected to the main part 150, a second bracket 142 connected to the vehicle, and a connecting pin 143 which connects the first bracket 141 and the second bracket 142 to allow the first bracket 141 and the second bracket 142 to rotate a predetermined extent.

The first bracket 141 may be forms as a plate member through which the checker arm 130 passes, and one side of the first bracket 141 may be connected to the main part 150. Preferably, the first bracket 141 may be formed of the plate member substantially having a “C” shape of which an upper end and a lower end are bent. The first bracket 141 may be disposed to face the second bracket 142 and connected to the second bracket 142 by the connecting pin 143.

Like the first bracket 141, the second bracket 142 may be formed of a plate member through which the checker arm 130 passes, and one side of the second bracket 142 may be connected to the door of the vehicle. Preferably, the second bracket 142 may be formed of the plate member having a substantially “C” shape of which an upper end and a lower end are bent.

The connecting pin 143 may be formed as a pin which connects the first bracket 141 and the second bracket 142 and may connect bent portions of upper and lower ends of the first and second brackets 141 and 142. The connecting pin 143 may rotatably connect the first and second brackets 141 and 142 such that the first and second brackets 141 and 142 rotate the predetermined extent while the vehicle door opener 100 operates.

Specifically, while the door is opened or closed from the vehicle body of the vehicle, interference between the checker arm 130 and the components disposed such that the checker arm 130 passes through the components may occur. In this case, as the first and second brackets 141 and 142 connected by the connecting pin 143 rotate the predetermined extent, the interference can be avoided.

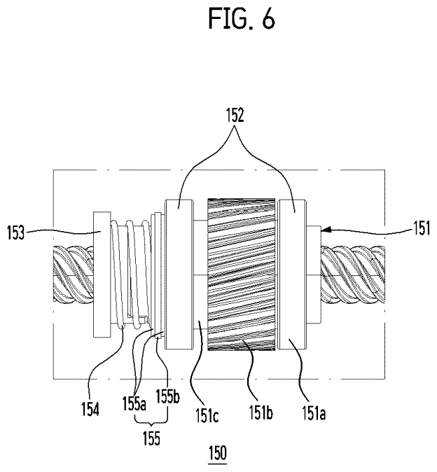

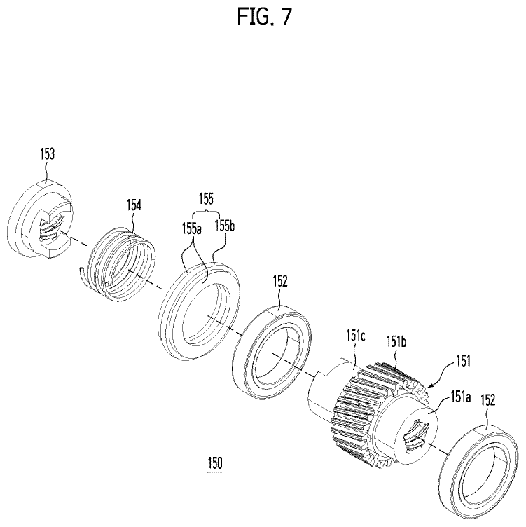

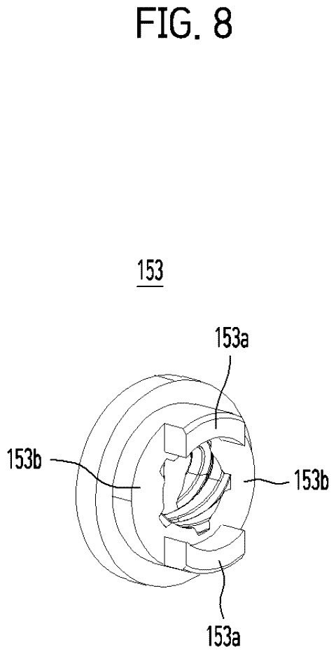

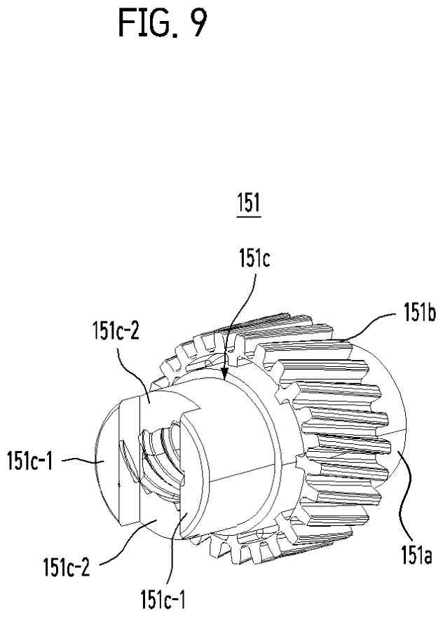

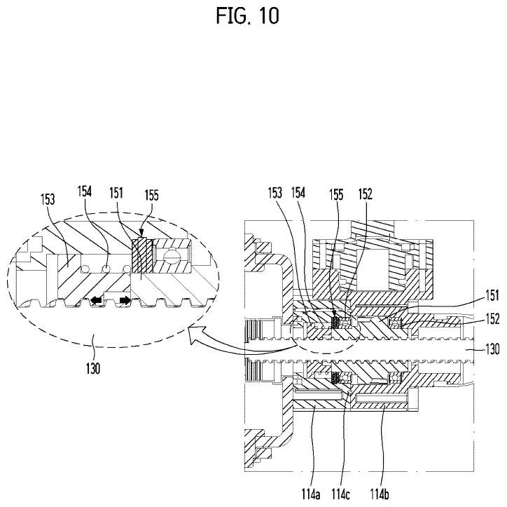

FIG. 6 is an enlarged view illustrating the main part illustrated in FIG. 4, and FIG. 7 is an exploded view illustrating the main part illustrated in FIG. 4. FIG. 8 is an enlarged view illustrating a nut part illustrated in FIG. 4, and FIG. 9 is an enlarged view illustrating the worm wheel illustrated in FIG. 4. FIG. 10 is a cross-sectional view illustrating the vehicle door opener illustrated in FIG. 1.

Further referring to FIGS. 6 to 10, the main part 150 may be disposed such that the checker arm 130 passes through the main part 150 and may move along the outer circumferential surface of the checker arm 130. Specifically, the main part 150 may be disposed such that the checker arm 130 passes through the main part 150 in a state in which the worm wheel 151 and a nut part 153 having inner circumferential surfaces, on which screw threads are formed, are engaged with the outer circumferential surface of the checker arm 130, and the main part 150 may be moved in the longitudinal direction of the checker arm 130.

Specifically, the main part 150 may include the worm wheel 151 of which an outer circumferential surface is engaged with the worm 121 and the inner circumferential surface is engaged with the checker arm 130, bearings 152 disposed between the worm wheel 151 and the main case 114, the nut part 153 which is disposed at one side of the worm wheel 151 and through which the checker arm 130 passes, and an elastic part 154 and a brake assembly 155 which are disposed between the worm wheel 151 and the nut part 153.

The worm wheel 151 may be formed of a cylindrical member of which a center is open and disposed such that the checker arm 130 passes through the worm wheel 151. Specifically, the inner circumferential surface of the worm wheel 151 may be engaged with the checker arm 130, and a portion of the outer circumferential surface of the worm wheel 151 may be engaged with the worm 121. Both sides of the worm wheel 151 may be formed to extend based on a portion engaged with the worm 121, and the bearings 152 may be disposed on the outer circumferential surface of the worm wheel 151. That is, the screw thread may be formed on the entire inner circumferential surface of the worm wheel 151 and may be engaged with the checker arm 130. In addition, a screw thread may be formed on an outer circumferential surface of an engagement part 151b and engaged with the worm 121.

Specifically, the worm wheel 151 may include a first worm wheel member 151a formed to extend from the engagement part 151b and including an outer circumferential surface on which one of the bearings 152 is disposed, the engagement part 151b having the outer circumferential surface on which the screw thread is formed and with which the worm 121 is engaged, and a second worm wheel member 151c formed to extend from the engagement part 151b and including an outer circumferential surface on which the other of the bearings 152 and the elastic part 154 are disposed.

In the engagement part 151b, the screw thread may be formed on the outer circumferential surface and engaged with the worm 121.

The first worm wheel member 151a may be formed at one side of the engagement part 151b to extend toward the checker arm 130, and the bearing 152 may be disposed on the outer circumferential surface of the first worm wheel member 151a. Specifically, the first worm wheel member 151a may be formed to extend in a direction in which the stopper 132 is disposed.

The second worm wheel member 151c may be formed at one side of the engagement part 151b to extend toward the checker arm 130, and the bearing 152 and the elastic part 154 may be disposed on the outer circumferential surface of the second worm wheel member 151c. Specifically, the second worm wheel member 151c may be formed to extend in a direction in which the nut part 153 is disposed.

The first and second worm wheel members 151a and 151c may be disposed at opposite sides based on the engagement part 151b, the bearings 152 may be disposed on the outer circumferential surfaces of the first and second worm wheel members 151a and 151c, and thus the first and second worm wheel members 151a and 151c may be balanced and operated.

Specifically, the second worm wheel member 151c may include an extension worm wheel portion 151c-1 formed to extend along the outer circumferential surface of the checker arm 130 and a flat worm wheel portion 151c-2 formed to have a smaller length than the extension worm wheel portion 151c-1.

An end of one side of the second worm wheel member 151c may extend along the outer circumferential surface of the checker arm 130 to form the extension worm wheel portion 151c-1. Preferably, the extension worm wheel portion 151c-1 may be provided as a plurality of extension worm wheel portions 151c-1 disposed to be spaced a predetermined distance from each other.

The flat worm wheel portion 151c-2 may be formed to have the smaller length than the extension worm wheel portion 151c-1.

The extension worm wheel portions 151c-1 and the flat worm wheel portions 151c-2 may be alternately disposed. Specifically, the extension worm wheel portion 151c-1 and the flat worm wheel portion 151c-2 may be formed to correspond to a flat nut portion 153b and an extension nut portion 153a of the nut part 153, which will be described below.

The bearings 152 may be disposed between the outer circumferential surface of the worm wheel 151 and the cover part 110 such that the worm wheel 151 smoothly rotates. Specifically, the bearing 152 may be disposed on each of the first worm wheel member 151a and the second worm wheel member 151c and between the first worm wheel member 151a and second worm wheel member 151c and the main case 114.

The nut part 153 may be formed of a cylindrical member of which a center is open, disposed such that the checker arm 130 passes through the nut part 153, and disposed at one side of the worm wheel 151. Specifically, the screw thread may be formed on the inner circumferential surface of the nut part 153 and may be engaged with the checker arm 130. The elastic part 154 may be disposed on the outer circumferential surface of the nut part 153, and a force may be applied in a direction opposite to the worm wheel 151. A circumferential surface of an end of the nut part 153 opposite to the worm wheel 151 may be formed to protrude, and the elastic part 154 may be fixedly fitted to the portion formed to protrude.

Specifically, the nut part 153 may include the extension nut portion 153a formed to extend along the outer circumferential surface of the checker arm 130 and the flat nut portion 153b formed to have a smaller length than the extension nut portion 153a. The extension nut portion 153a and the flat nut portion 153b may be disposed on an end close to a portion, on which the worm wheel 151 is disposed, to be engaged with the extension worm wheel portion 151c-1 and the flat worm wheel portion 151c-2 of the second worm wheel member 151c.

An end of one side of the nut part 153 may extend along the outer circumferential surface of the checker arm 130 to form the extension nut portion 153a. Preferably, the extension nut portion 153a may be formed to correspond to the flat worm wheel portion 151c-2 of the second worm wheel member 151c.

The flat nut portion 153b may be formed to have the smaller length than the extension nut portion 153a.

The extension nut portion 153a and the flat nut portion 153b may be alternately disposed. Specifically, the extension nut portions 153a and the flat nut portions 153b may be formed to correspond to the flat worm wheel portions 151c-2 and the extension worm wheel portions 151c-1 of the second worm wheel member 151c. That is, the end of the nut part 153 and the end of the second worm wheel member 151c may be disposed to be engaged with each other. The elastic part 154 may be disposed on an outer circumferential surface of a portion at which the nut part 153 and the second worm wheel member 151c are engaged with each other to press the worm wheel 151 and the nut part 153 in opposite directions.

The elastic part 154 may be formed of a member having an elastic restoring force and disposed between the worm wheel 151 and the nut part 153. Specifically, the elastic part 154 may be disposed between the worm wheel 151 and the nut part 153 to push the worm wheel 151 and the nut part 153 in the opposite directions. For example, a spring may be used for at least a portion of the elastic part 154. That is, the elastic part 154 may push the worm wheel 151 and the nut part 153 to bring a gear of the outer circumferential surface of the checker arm 130 and gears of the inner circumferential surfaces of the worm wheel 151 and the nut part 153 into close contact with each other. Accordingly, the elastic part 154 may have an effect of anti-backlash which prevents a backlash phenomenon by preventing movement of the checker arm 130, the worm wheel 151, and the nut part 153 relative to each other.

The brake assembly 155 may be disposed between the bearing 152 and the elastic part 154 to increase a load of the motor part 120. The brake assembly 155 may be pressed by the elastic part 154, so that the main part 150 may be prevented from being vertically moved relative to the checker arm 130.

In some embodiments, the brake assembly 155 may include a brake pad 155a. The brake pad 155a may be formed of a plate member, in which an opening is formed at a center, and disposed such that the worm wheel 151 passes through the brake pad 155a. The brake pad 155a may be pressed by the elastic part 154 and rubbed in one direction to generate a braking force.

For example, at least a portion of the brake pad 155a may be formed of a metal material. As described above, the brake pad 155a of which at least the portion is formed of the metal material may be disposed on a portion in contact with the elastic part 145 and/or the bearing 152 in order to improve durability.

Alternatively, at least a portion of the brake pad 155a may be formed of polytetrafluoroethylene (PTFE). As described above, the brake pad 155a of which at least the portion is formed of the PTFE may be disposed on a portion in contact with a brake washer 155b in order to improve a frictional force.

In addition, in some embodiments, the brake assembly 155 may include the brake washer 155b. The brake washer 155b may be formed of a plate member, in which an opening is formed at a center, like or similarly to the brake pad 155a. The brake washer 155b may be disposed between a pair of brake pads 155a and rubbed with the brake pads 155a to act as a brake.

Hereinafter, an assembly process of the vehicle door opener 100 will be described below.

First, the first main body cover 114a and the second main body cover 114b are disposed such that the checker arm 130 passes through one of the first main body cover 114a and the second main body cover 114b. Next, the worm wheel 151, the nut part 153, and the elastic part 154 are sequentially coupled thereto. Next, the first main body cover 114a and the second main body cover 114b are disposed such that the checker arm 130 passes through the other of the first main body cover 114a and the second main body cover 114b, and then the hook 114a-1 is fastened to the fastening protrusion 114b-1 to fixedly fasten the first main body cover 114a and the second main body cover 114b.

The above-described assembly method may be used in order to couple the main case 114 in a state in which the elastic part 154 is disposed between the worm wheel 151 and the nut part 153 to push the worm wheel 151 and the nut part 153 relative to each other.

As described above, since the vehicle door opener 100 according to the embodiments of the present disclosure includes the anti-backlash structure, there are effects of suppressing the generation of vibrations and noise and improving operability. Specifically, in the present disclosure, since the elastic part 154 is disposed between the worm wheel 151 and the nut part 153 which are engaged with the outer circumferential surface of the checker arm 130, the main part 150 can be properly engaged with the checker arm 130. Accordingly, while the main part 150 moves along the checker arm 130, a state in which the gears are engaged with each other is continuously maintained, and thus backlash can be properly maintained. That is, a use lifetime of the vehicle door opener 100 of the present disclosure can increase, and the operability thereof can be improved.

In addition, the vehicle door opener 100 according to the embodiments of the present disclosure has characteristics that sealing and water tightness can be improved and the worm 121 can be prevented from being sagged downward due the structure of the cover part 110. Specifically, since the cover part 110 of the present disclosure includes the packing part 114c at portions in contact with and coupled to each other, external foreign matter can be effectively prevented from being introduced thereinto. In addition, since the cover part 110 of the present disclosure includes the support 114a-2 which supports the end of the worm 121, the worm 121 can be prevented from being sagged downward and supported to stably move.

Since a vehicle door opener according to embodiments of the present disclosure includes an anti-backlash structure, there are effects of suppressing the generation of vibrations and noise and improving operability. Specifically, in the present disclosure, since an elastic part is disposed between a worm wheel and a nut part which are engaged with an outer circumferential surface of a checker arm, a main part can be properly engaged with the checker arm. Accordingly, since a state in which gears are engaged with each other is continuously maintained while the main part moves along the checker arm, backlash can be properly maintained, a use lifetime of the vehicle door opener can be increased, and the operability thereof can be improved.

In addition, the vehicle door opener according to the embodiments of the present disclosure has characteristics that sealing and water tightness can be improved and a worm can be prevented from being sagged downward due a structure of a cover. Specifically, since the cover of the present disclosure includes a packing part at portions in contact with and coupled to each other, external foreign matter can be effectively prevented from being introduced thereinto. In addition, since the cover of the present disclosure includes a support which supports an end of the worm, the worm can be prevented from being sagged downward and supported to stably move.

However, technical effects that can be obtained through embodiments of the present disclosure are not necessarily limited to the above-described effects. Other technical effects that are not described above may be clearly understood by those skilled in the art to which the present disclosure belongs from the other descriptions of the specification such as the detailed description.

While embodiments of the present disclosure have been described above, the present disclosure may be variously modified and changed by those skilled in the art by adding, changing, or removing components without departing from the spirit of the present disclosure appended in the claims, and these also fall within the scope of the present disclosure.

What is claimed is:

1. A vehicle door opener comprising:
a checker arm which is hinge-coupled to a main body of a vehicle and in which a screw thread is formed on an outer circumferential surface of the checker arm;
a main part which moves along the checker arm when a door is opened or closed;
a motor part which moves the main part; and
a cover part in which the checker arm and the main part are disposed,
wherein the main part includes:
a worm wheel which is engaged with the outer circumferential surface of the checker arm and of which both sides are formed to extend based on a portion with which a worm of the motor part is engaged;
a nut part which is engaged with the outer circumferential surface of the checker arm and disposed at one side of the worm wheel; and
an elastic part which is formed of a member having an elastic restoring force and disposed to surround outer circumferential surfaces of the worm wheel and the nut part to push the worm wheel and the nut part in opposite directions.

2. The vehicle door opener of claim 1, wherein the worm wheel includes:
an engagement part having an outer circumferential surface and an inner circumferential surface on which screw threads formed, wherein the outer circumferential surface is engaged with the worm of the motor part, and the inner circumferential surface is engaged with the checker arm and moved along the outer circumferential surface of the checker arm by operation of the motor part; and
a first worm wheel member and a second worm wheel member disposed at both sides of the engagement part and having inner circumferential surfaces on which screw threads formed and engaged with the outer circumferential surface of the checker arm and outer circumferential surfaces on which bearings in contact with the cover part are disposed.

3. The vehicle door opener of claim 2, wherein the second worm wheel member includes:
an extension worm wheel portion of which an end is formed to extend along the outer circumferential surface of the checker arm; and
a flat worm wheel portion formed to have a smaller length than the extension worm wheel portion,
wherein the extension worm wheel portion and the flat worm wheel portion are alternately disposed.

4. The vehicle door opener of claim 1, wherein the nut part includes:
an extension nut portion of which an end close to a portion on which the worm wheel is disposed is formed to extend along the outer circumferential surface of the checker arm; and
a flat nut portion formed to have a smaller length than the extension nut portion,
wherein the extension nut portion and the flat nut portion are alternately disposed.

5. The vehicle door opener of claim 1, wherein the cover part includes a motor case and a terminal case which are formed to correspond to each other and fixedly coupled to each other,
wherein each of the motor case and the terminal case includes:
a plurality of fastening holes disposed to be spaced at an equal interval from each other; and
the terminal case is rotation-coupled to the motor case as needed.

6. The vehicle door opener of claim 1, wherein:
the cover part includes a main case in which the main part is disposed;
the main case includes a second main body cover including a fastening protrusion formed to protrude from an outer circumferential surface of the second main body cover and a first main body cover including a hook in which a member, in which a hole or groove is formed to be fastened to the fastening protrusion, is disposed; and
the first main body cover and the second main body cover are fixedly fastened by coupling of the hook and the fastening protrusion.

7. The vehicle door opener of claim 6, wherein the main case includes a packing part disposed between the first main body cover and the second main body cover to improve sealing between the first main body cover and the second main body cover.

8. The vehicle door opener of claim 6, wherein the first main body cover includes a support which protrudes toward a lower side of the worm of the motor part in the first main body cover and is disposed in contact with or close to a lower end of the worm to prevent the worm from being sagged downward.

9. The vehicle door opener of claim 1, further comprising a brake assembly disposed at the one side of the worm wheel to increase a load of the motor part.

10. The vehicle door opener of claim 9, wherein the brake assembly includes:
a pair of brake pads disposed such that the worm wheel passes through the pair of brake pads; and
a brake washer which is disposed between the brake pads and is rubbed with the brake pads to act as a brake.
